(19) United States
(12) Patent Application Publication
(10) Pub. No.: US 2006/0125405 A1
(43) Pub. Date: Jun. 15, 2006

(54) Green sheet and method for manufacturing plasma display panel

(75) Inventors: Byung Hwa Seo, Seoul (KR); Myung Won Lee, Seoul (KR); Je Seok Kim, Gyeonggi-do (KR); Byung Gil Ryu, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/302,429

(22) Filed: Dec. 14, 2005

(30) Foreign Application Priority Data
Dec. 14, 2004 (KR) 10-2004-0105783

(51) Int. Cl. H01J 7/24

(52) U.S. Cl. 315/111.21

(57) ABSTRACT

A green sheet, and a method for manufacturing a plasma display panel are provided. The sheet comprises a base film; a dielectric dry film formed on the base film, and comprising a glass powder, a polymer binder of 15 wt % to 30 wt %, and a plasticizer of 1.5 wt % to 3 wt %; and a cover film formed on the dielectric dry film.

This Nonprovisional application claims priority under 35 U.S.C. § 119(a) on Patent Application No. 2004-105783 filed in Korea on Dec. 14, 2004, the entire contents of which are hereby incorporated by reference.

### BACKGROUND OF THE INVENTION

1. Field of the Invention

The present document relates to a green sheet, and a method for manufacturing a plasma display panel.

2. Description of the Background Art

In general, a plasma display panel is comprised of a front substrate and a rear substrate formed of soda-lime glass. A barrier rib formed between the front substrate and the rear substrate partitions a discharge cell. Inert gas such as helium-xenon (He—Xe) and helium-neon (He—Ne) injected into the discharge cell generates a discharge by a high frequency voltage. When the discharge is generated, vacuum ultraviolet rays are generated, and the vacuum ultraviolet rays excite a phosphor provided between barrier ribs, thereby embodying an image.

FIG. 1 illustrates a structure of a conventional plasma display panel. As shown in FIG. 1, the conventional plasma display panel is comprised of a front panel 100 and a rear panel 110. The front panel 100 comprises a rear glass substrate 101, and the rear panel 110 comprises a rear glass substrate 111. The front panel 100 and the rear panel 110 are sealed in parallel to be at a predetermined distance.

A sustain electrode pair 102 and 103 for sustaining light emission of the cell by a mutual discharge are formed on the front glass substrate 101. The sustain electrode pair 102 and 103 are comprised of a scan electrode 102 and a sustain electrode 103. The scan electrode 102 and the sustain electrode 103 each are transparent electrodes 102-a and 103-a formed of transparent indium tin oxide (ITO) and bus electrodes 102-b and 103-b formed of metal. The scan electrode 102 receives a scan signal for panel scan, and a sustain signal for discharge sustain. The sustain electrode 103 mainly receives a sustain signal. An upper dielectric layer 104 is formed on the sustain electrodes 102 and 103, and limits a discharge current and insulates between the scan electrode 102 and the sustain electrode 103. A protective layer 105 is formed on an upper surface of the upper dielectric layer 104, and is formed of magnesium oxide (MgO) to facilitate a discharge condition.

An address electrode 113 is disposed to intersect with the sustain electrode pair 102 and 103 on the rear glass substrate 111. A lower dielectric layer 115 is formed on the address electrode 113, and insulates between the address electrodes. A barrier rib 112 is formed on the lower dielectric layer 115, and partitions a discharge cell. Red (R), green (G), and blue (B) phosphor layers 114 are coated between the barrier ribs 112, and emit visible rays for displaying an image.

The front panel 100 and the rear panel 110 are coalesced by a sealing material. After the coalescing of the front panel 100 and the rear panel 110, inert gas such as helium (He), neon (Ne), and xenon (Xe) is injected into the plasma display panel.

In the conventional plasma display panel, the upper dielectric layer 104 formed in the front panel 100 forms wall charges to sustain the discharge by a discharge sustain voltage, protects the electrode from ion impact in discharge, serves as a diffusion prevention layer, and serves as a base layer of the protective layer 105.

In order to form the upper dielectric layer 104 or the lower dielectric layer 115, a screen-printing method is used. In the screen-printing method, the upper dielectric layer 104 or the lower dielectric layer 115 is formed by printing a dielectric paste on the front glass substrate 101 on which the scan electrode 102 and the sustain electrode 103 are formed or on the rear glass substrate 111 on which the address electrode 113 is formed, using a mask.

The screen-printing method for forming the upper dielectric layer 104 or the lower dielectric layer 115 can reduce a cost necessary for forming the upper dielectric layer 104 or the lower dielectric layer 115 but, cannot equalize a thickness of the dielectric layer.

### SUMMARY OF THE INVENTION

Accordingly, an object of an embodiment of the present invention is to solve at least the problems and disadvantages of the background art.

An object of an embodiment of the present invention is to provide a green sheet capable of equalizing a thickness of a dielectric layer.

Another object of an embodiment of the present invention is to provide a method for manufacturing a plasma display panel, capable of equalizing a thickness of a dielectric layer.

To achieve these and other advantages and in accordance with the purpose of the present invention, as embodied and broadly described, there is provided a green sheet of a plasma display panel comprising a base film, a dielectric dry film formed on the base film, and comprising a glass powder, a polymer binder of 15 wt % to 30 wt % and a plasticizer of 1.5 wt % to 3 wt %; and a cover film formed on the dielectric dry film.

In another aspect of the present invention, there is provided a method for manufacturing a plasma display panel comprising the steps of preparing a substrate, forming an electrode on the substrate and laminating a dielectric dry film on the substrate on which the electrode is formed.

The green sheet and the manufacturing method of the plasma display panel in accordance with an embodiment of the invention can form the dielectric layer of a uniform thickness.

The green sheet and the manufacturing method of the plasma display panel in accordance with an embodiment of the invention can reduce a space between an argentum electrode and the dielectric dry film.

The green sheet and the manufacturing method of the plasma display panel in accordance with an embodiment of the invention can prevent dielectric breakdown and electrode discoloration

### BRIEF DESCRIPTION OF THE DRAWINGS

Embodiments of the invention will be described in detail with reference to the following drawings in which like numerals refer to like elements.

FIG. 1 illustrates a structure of a conventional plasma display panel;

FIG. 2 illustrates a structure of a green sheet according to an embodiment of the present invention;

FIGS. 3A and 3B illustrate a method for forming a green sheet according to an embodiment of the present invention;

FIG. 4 illustrates a method for manufacturing a plasma display panel according to, an embodiment of the present invention;

FIGS. 5A to 5C illustrate a method for manufacturing a front panel of a plasma display panel according to the present invention; and

FIGS. 6A to 6C illustrate a method for manufacturing a rear panel of a plasma display panel according to the present invention.

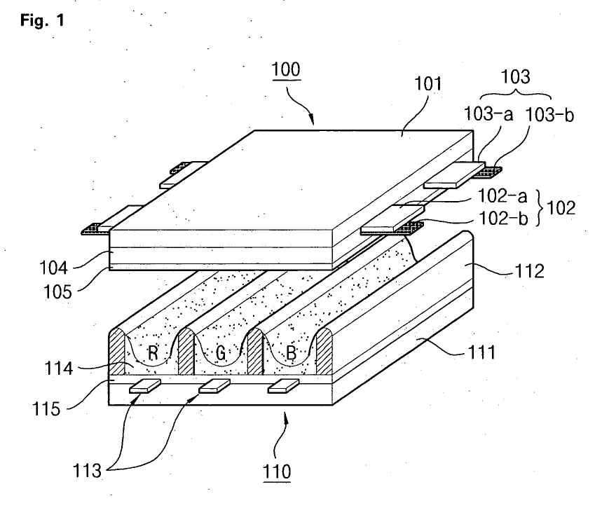

### DETAILED DESCRIPTION OF PREFERRED EMBODIMENTS

Preferred embodiments of the present invention will be described in a more detailed manner with reference to the drawings.

A green sheet of a plasma display panel according to an embodiment of the present invention comprises: a base film; a dielectric dry film formed on the base film, and comprising a glass powder, a polymer binder of 15 wt % to 30 wt %, and a plasticizer of 1.5 wt % to 3 wt %; and a cover film formed on the dielectric dry-film.

An average diameter of a particle of the glass powder is equal to or more than 0.5 μm to less than or equal to 3.0 μm.

A weight percent of the glass powder is equal to or more than 52 wt % to less than or equal to 83 wt %.

The polymer binder is an acrylate based polymer binder of which a glass transition temperature is equal to or more than −20° C. to less than or equal to 30° C.

The molecular weight of the polymer binder is equal to or more than 10,000 g/mol to less than or equal to 100,000 g/mol.

The dielectric dry film further comprises a dispersing agent of which the weight percent is equal to or more than 0.5 wt % to less than or equal to 3 wt %.

The plasticizer comprises at least one of DOA (dioctyl adipate), DOP (dioctyl phthalate), DBP (dibutyl phthalate), BBP (butyl benzyl phthalate), and DINP (diisononyl phthalate).

A method for manufacturing a plasma display panel according to an embodiment of the present invention comprises the steps of: preparing a substrate; forming an electrode on the substrate; and laminating a dielectric dry film on the substrate on which the electrode is formed.

The electrode is a scan electrode and a sustain electrode.

The electrode is an address electrode.

The dielectric dry film comprises a glass powder, a polymer binder of 15 wt % to 30 wt %, and a plasticizer of 1.5 wt % to 3 wt %.

An average diameter of a particle of the glass powder is equal to or more than 0.5 μm to less than or equal to 3.0 μm.

A weight percent of the glass powder is equal to or more than 52 wt % to less than or equal to 83 wt %.

The polymer binder is an acrylate based polymer binder of which a glass transition temperature is equal to or more than −20° C. to less than or equal to 30° C.

The molecular weight of the polymer binder is equal to or more than 10,000 g/mol to less than or equal to 100,000 g/mol.

The dielectric dry film further comprises a dispersing agent of which the weight percent is equal to or more than 0.5 wt % to less than or equal to 3 wt %.

The plasticizer comprises at least one of DOA (dioctyl adipate), DOP (dioctyl phthalate), DBP (dibutyl phthalate), BBP (butyl benzyl phthalate), and DINP (diisononyl phthalate).

Hereinafter, an embodiment of the present invention will be in detail described with reference to the attached drawings.

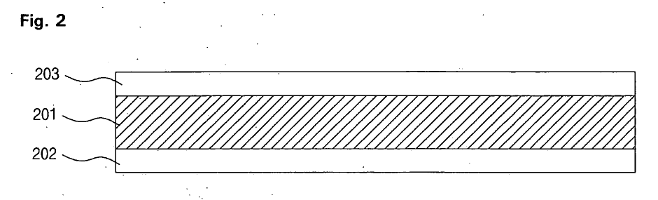

FIG. 2 illustrates a structure of a green sheet according to an embodiment of the present invention. As shown in FIG. 2, the inventive green sheet comprises a base film 202, a dielectric dry film 201, and a cover film 203. The dielectric dry film 201 is formed on the base film 202, and the cover film 203 is formed on the dielectric dry film 201 to protect the dielectric dry film 201.

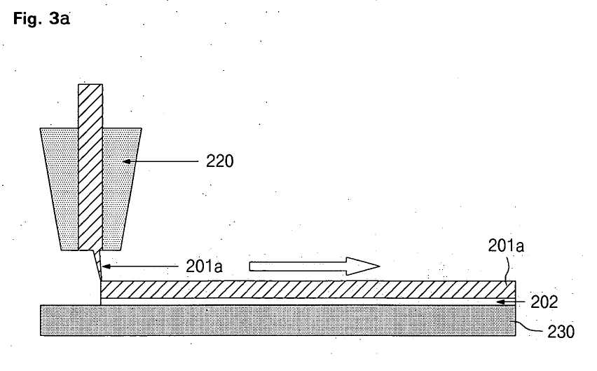

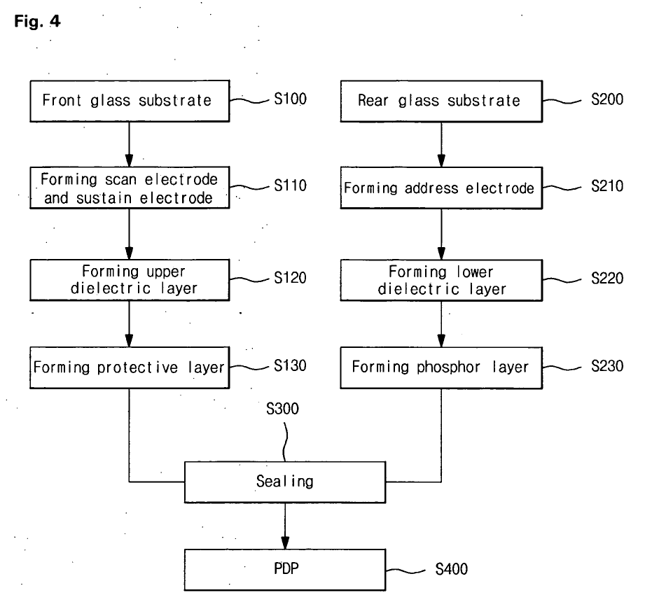

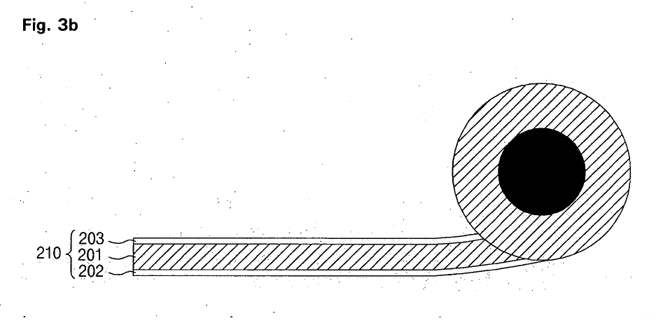

FIGS. 3A and 3B illustrate a method for forming the dielectric green sheet according to an embodiment of the present invention.

As shown in FIG. 3A, a slurry 201a comprising an organic substance and a dielectric substance mixed in a coater 220 is coated on the base film 202 formed on a conveyor belt 230. The base film 202 is formed of polyethylene telephthalate (PET).

As shown in FIG. 3B, the slurry 201a coated on the base film 202 is dried, thereby forming the dielectric dry film 201. The cover film 203 covers an upper surface of the dielectric dry film 201, thereby completing the inventive green sheet. The green sheet is manufactured in a roll form.

FIG. 4 illustrates a composition substance and a composition ratio of the dielectric dry film comprised in the inventive green sheet. As shown in FIG. 4, the dielectric dry film 201 of the inventive green sheet 210 comprises a glass powder, a polymer binder, a dispersing agent, and a plasticizer.

The glass powder has a permittivity and a permeability representing an electrical characteristic of the dielectric substance.

The polymer binder is to form a shape of the dielectric dry film 201, and is an acrylate based polymer of which a glass transition temperature (Tg) is equal to or more than −20° C. to less than or equal to 30° C.

A weight percent of the polymer binder is equal to or more than 15 wt % to less than or equal to 30 wt % of a total weight of the dielectric dry film. The molecular weight of the polymer binder is equal to or more than 10,000 g/mol to less than or equal to 100,000 g/mol. The weight percent, the glass transition temperature, and the molecular weight of the polymer binder are to improve a plasticity of the dielectric dry film.

The dispersing agent allows a uniform mixture of the glass powder and the polymer binder.

The plasticizer provides the plasticity to the polymer binder. The plasticity refers to a property in which, when a solid is excessively deformed due to an external applied force, it does not return to its original state even though the external force is removed. The weight percent of the plasticizer is equal to or more than 1.5 wt % to less than or equal to 15 wt %. The plasticizer comprised in the dielectric dry film of the inventive green sheet comprises at least one of dioctyl adipate (DOA), dioctyl phthalate (DOP), dibutyl phthalate (DBP), butyl benzyl phthalate (BBP), and diisononyl phthalate (DINP).

A method for manufacturing a plasma display panel using the inventive green sheet 210 will be described in detail.

FIG. 4 illustrates the method for manufacturing the plasma display panel according to an embodiment of the present invention. As shown in FIG. 4, the inventive manufacture method comprises a front panel manufacture process (Steps 100 to 130), a rear panel manufacture process (Steps 200 to 230), and an assembly process (Steps 300 and 400).

The front panel manufacture process (Steps 100 to 130) is as follows. After a front glass substrate is prepared (Step 100), a plurality of sustain electrode pairs are formed on the front glass substrate (Step 110). An upper dielectric layer is formed on the sustain electrode pair (Step 120), and: a protective layer is formed of magnesium oxide (MgO) on the upper dielectric layer to protect the sustain electrode pair (Step 130).

The rear panel manufacture process (Steps 200 to 230) is as follows. After a rear glass substrate is prepared (Step 200), a plurality of address electrodes are formed on the rear glass substrate to intersect with the sustain electrode pair formed in the front panel (Step 210). A lower dielectric layer is formed on the address electrode (Step 220), and a phosphor layer is formed on an upper surface of the lower dielectric layer (Step 230).

Thus manufactured front panel and rear panel are sealed with each other (Step 300), thereby forming the plasma display panel (Step 400).

The upper dielectric layer or the lower dielectric layer is formed using the inventive green sheet.

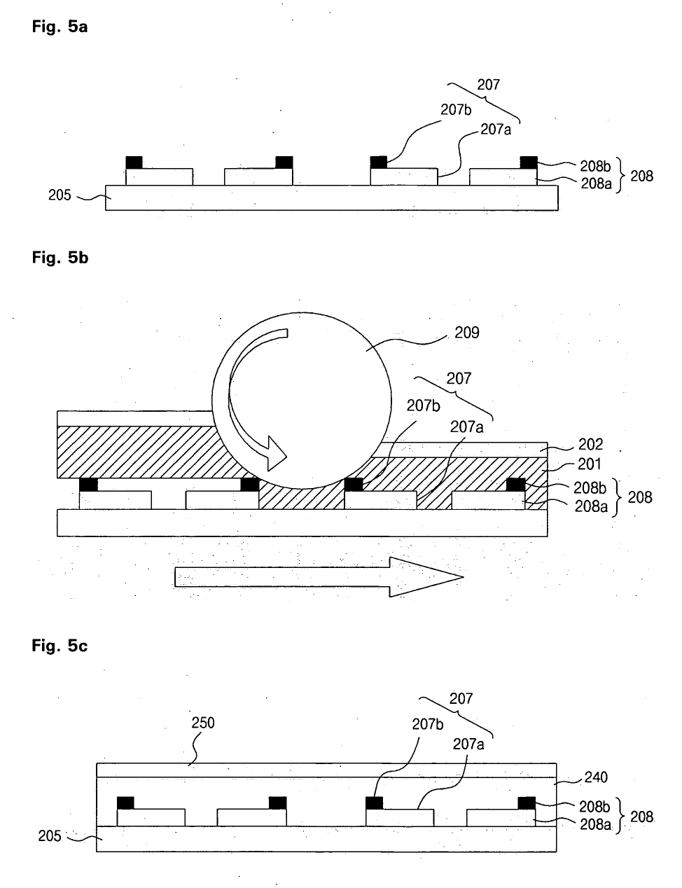

FIGS. 5A to 5C illustrate a method for manufacturing the front panel of the plasma display panel according to the present invention.

As shown in FIG. 5A, a scan electrode 207 and a sustain electrode 208 are formed on the front glass substrate 205. The scan electrode 207 and the sustain electrode 208 are comprised of transparent electrodes 207a and 208a, and bus electrodes 207b and 208b.

A forming process of the transparent electrodes 207a and 208a comprises the steps of laminating the dry film formed of indium tin oxide (ITO), on a front glass substrate 205; exposing the dry film using a photo mask having a pattern of the transparent electrode; and forming the scan transparent electrode 207a and the sustain transparent electrode 208a through development.

A forming process of the bus electrodes 207b and 208b comprises the steps of printing a photosensitive argentum (Ag) paste in the screen-printing method; exposing the photosensitive argentum paste formed of ITO, using a photo mask having a pattern of the bus electrode; and forming the scan bus electrode 207b and the sustain bus electrode 208b through development.

If the transparent electrodes 207a and 208a and the bus electrodes 207b and 208b are formed and fired at 550° C., the transparent electrodes 207a and 208a and the bus electrodes 207b and 208b are integrated, thereby forming the scan electrode 207 and the sustain electrode 208.

After the forming of the scan electrode 207 and the sustain electrode 208, the upper dielectric layer is formed using the inventive green sheet.

As shown in FIG. 5B, the dielectric dry film 201 and the base film 202 of the green sheet 210 from which the cover film (not shown) is removed are laminated by the roller 209 on the front glass substrate 205 on which the scan electrode 207 and the sustain electrode 208 are formed and then, the base film 202 is removed.

Since the inventive green sheet is laminated using the roller 209, the upper dielectric layer of a uniform thickness can be formed. The dielectric dry film 201 of the inventive green sheet comprises the polymer binder of 15 wt % to 30 wt % and the plasticizer of 1.5 wt % to 15 wt % and therefore, the dielectric dry film 201 has a plasticity as much as to be pushed into a boundary region between the scan electrode 207 or the sustain electrode 208 and the front glass substrate 205. Accordingly, a void space between the scan electrode 207 or the sustain electrode 208 and the dielectric dry film 201 is reduced.

When the weight percent of the the glass powder of the dielectric dry film 201 is equal to or more than 52 wt % to less than or equal to 83 wt %, and an average diameter of a particle of the glass powder is equal to or more than 0.5 μm to less than or equal to 3.0 μm, the dielectric dry film 201 is more improved in plasticity, thereby more reducing the void space between the scan electrode 207 or the sustain electrode 208 and the dielectric dry film 201.

When the weight percent of the dispersing agent of the dielectric dry film 201 is equal to or more than 0.5 wt % to less than or equal to 3 wt %, the dielectric dry film 201 is more improved in plasticity, thereby more reducing the void space between the scan electrode 207 or the sustain electrode 208 and the dielectric dry film 201.

As the void space between the scan electrode 207 or the sustain electrode 208 and the dielectric dry film 201 reduces, an insulating property between the scan electrode 207 and the sustain electrode 208 is secured, and the electrode is prevented from being discolored due to migration.

As shown in FIG. 5C, the protective layer 250 is formed of magnesium oxide (MgO) on the upper dielectric layer 240 using a chemical vapor deposition (CVD) method, an ion plating method, or a vacuum deposition method. If the protective layer 250 is formed, the front panel of the plasma display panel is completed.

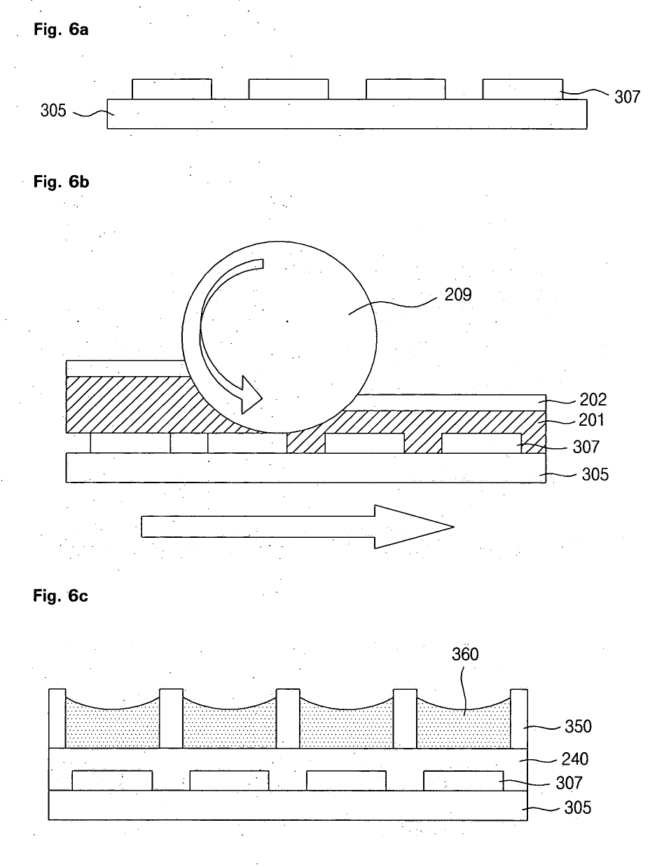

FIGS. 6A to 6c illustrate a method for manufacturing the rear panel of the plasma display panel according to the present invention.

As shown in FIG. 6A, an address electrode 307 is formed on a rear glass substrate 305. A forming process of the address electrode 307 comprises the steps of printing a photosensitive argentum (Ag) paste in the screen-printing method; exposing the photosensitive argentum paste formed of ITO, using a photo mask having a pattern of the address electrode 307; and forming the address electrode 307 through development.

As shown in FIG. 6B, the dielectric dry film 201 and the base film 202 of the green sheet 210 from which the cover film (not shown) is removed are laminated by the roller 209 on a rear glass substrate 305 on which the address electrode 307 is formed, and then the base film 202 is removed.

Since the inventive green sheet is laminated using the roller 209, the upper dielectric layer of a uniform thickness is formed. The dielectric dry film 201 of the inventive green sheet comprises the polymer binder of 15 wt % to 30 wt % and the plasticizer of 1.5 wt % to 15 wt % and therefore, the dielectric dry film 201 has a plasticity as much as to be pushed into a boundary region between the address electrode 307 and the rear glass substrate 305. Accordingly, a void space between the address electrode 307 and the dielectric dry film 201 is reduced.

When the weight percent of the glass powder of the dielectric dry film 201 is equal to or more than 52 wt % to less than or equal to 83 wt %, and an average diameter of the particle of the glass powder is equal to or more than 0.5 μm to less than or equal to 3.0 μm., the dielectric dry film 201 is more improved in plasticity, thereby more reducing the void space between the address electrode 307 and the dielectric dry film 201.

When the weight percent of the dispersing agent of the dielectric dry film 201 is equal to or more than 0.5 wt % to less than or equal to 3 wt %, the dielectric dry film 201 is more improved in plasticity, thereby more reducing the void space between the address electrode 307 and the dielectric dry film 201.

As the void space between the address electrode 307 and the dielectric dry film 201 reduces, an insulating property between the address electrode 307 and the dielectric dry film 201 is secured, and the electrode is prevented from being discolored due to migration.

As shown in FIG. 6C, a barrier rib 350 is formed through the screen-printing method, and a phosphor is coated between the barrier ribs 350, thereby forming a phosphor layer 360. If the phosphor layer 360 is formed, the rear panel of the plasma display panel is completed.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

What is claimed is:

1. A green sheet of a plasma display panel, the sheet comprising:
a base film;
a dielectric dry film formed on the base film, and comprising a glass powder, a polymer binder of 15 wt % to 30 wt % and a plasticizer of 1.5 wt % to 3 wt %; and
a cover film formed on the dielectric dry film.

2. The green sheet of claim 1, wherein an average diameter of a particle of the glass powder is equal to or more than 0.5 μm to less than or equal to 3.0 μm.

3. The green sheet of claim 1, wherein the weight percent of the glass powder is equal to or more than 52 wt % to less than or equal to 83 wt %.

4. The green sheet of claim 1, wherein the polymer binder is an acrylate based polymer binder of which a glass transition temperature is equal to or more than −20° C. to less than or equal to 30° C.

5. The green sheet of claim 1, wherein the molecular weight of the polymer binder is equal to or more than 10,000 g/mol to less than or equal to 100,000 g/mol.

6. The green sheet of claim 1, wherein the dielectric dry film further comprises a dispersing agent of which the weight percent is equal to or more than 0.5 wt % to less than or equal to 3 wt %.

7. The green sheet of claim 1, wherein the plasticizer comprises at least one of DOA (dioctyl adipate), DOP (dioctyl phthalate), DBP (dibutyl phthalate), BBP (butyl benzyl phthalate), and DINP (diisononyl phthalate).

8. A method for manufacturing a plasma display panel, the method comprising the steps of:
preparing a substrate;
forming an electrode on the substrate; and
laminating a dielectric dry film on the substrate on which the electrode is formed.

9. The method of claim 8, wherein the electrode is either a scan electrode or a sustain electrode.

10. The method of claim 8, wherein the electrode is an address electrode.

11. The method of claim 8, wherein the dielectric dry film comprises a glass powder, a polymer binder of 15 wt % to 30 wt %, and a plasticizer of 1.5 wt % to 3 wt %.

12. The method of claim 11, wherein an average diameter of a particle of the glass powder is equal to or more than 0.5 μm to less than or equal to 3.0 μm.

13. The method of claim 11, wherein a weight percent of the glass powder is equal to or more than 52 wt % to less than or equal to 83 wt %.

14. The method of claim 11, wherein the polymer binder is an acrylate based polymer binder of which a glass transition temperature is equal to or more than −20° C. to less than or equal to 30° C.

15. The method of claim 11, wherein the molecular weight of the polymer binder is equal to or more than 10,000 g/mol to less than or equal to 100,000 g/mol.

16. The method of claim 11, wherein the dielectric dry film further comprises a dispersing agent of which the weight percent is equal to or more than 0.5 wt % to less than or equal to 3 wt %.

17. The method of claim 11, wherein the plasticizer comprises at least one of DOA (dioctyl adipate), DOP (dioctyl phthalate), DBP (dibutyl phthalate), BBP (butyl benzyl phthalate), and DINP (diisononyl phthalate).
